(19) United States
(12) Patent Application Publication
(10) Pub. No.: US 2020/0033181 A1
(43) Pub. Date: Jan. 30, 2020

(54) LIQUID LEVEL DETECTOR

(71) Applicant: DENSO CORPORATION, Kariya-city (JP)

(72) Inventors: Isao MIYAGAWA, Kariya-city (JP); Atsushi HONDA, Nisshin-city (JP)

(21) Appl. No.: 16/595,597

(22) Filed: Oct. 8, 2019

Related U.S. Application Data
(63) Continuation of application No. PCT/JP2018/012262, filed on Mar. 27, 2018.

(30) Foreign Application Priority Data
May 16, 2017 (JP) 2017-097600

(51) Int. Cl. G01F 23/296; G01N 29/34

(52) U.S. Cl. CPC G01F 23/2962; G01N 2291/02836; G01N 29/341

(57) ABSTRACT

A liquid level detector includes an ultrasonic sensor that emits an ultrasonic wave toward a liquid surface of liquid in a tank, a driving circuit unit that provides a driving signal to the ultrasonic sensor to emit the ultrasonic wave, a reception circuit unit that detects a reflected wave signal that corresponds to a reflected wave from a received signal received by the ultrasonic sensor, and an arithmetic control circuit unit that computes a level of the liquid surface with the reflected wave signal. The liquid level detector further includes a temperature detection unit that detects a temperature of the liquid and a driving condition computing circuit unit that instructs the driving circuit unit to increase a strength of the driving signal as the temperature of the liquid that is detected by the temperature detection unit decreases.

### CROSS REFERENCE TO RELATED APPLICATION

The present application is a continuation application of International Patent Application No. PCT/JP2018/012262 filed on Mar. 27, 2018, which designated the U.S. and claims the benefit of priority from Japanese Patent Application No. 2017-097600 filed on May 16, 2017. The entire disclosures of all of the above applications are incorporated herein by reference.

### TECHNICAL FIELD

The present disclosure relates to a liquid level detector that detects a level of liquid surface of liquid in a tank by using an ultrasonic sensor.

### BACKGROUND

A known liquid level detector includes a tank that stores liquid, an ultrasonic sensor (ultrasonic vibration element) that emits an ultrasonic wave toward a liquid surface in the tank, a propagation path that is arranged in the tank, and a control circuit that calculates a level of the liquid surface.

### SUMMARY

A liquid level detector according to an aspect of the present disclosure includes an ultrasonic sensor, a driving circuit unit, a reception circuit unit, and an arithmetic control circuit unit. The liquid level detector further includes a temperature detection unit and a driving condition computing circuit unit.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory view showing an overall structure of a liquid level detector.

FIG. 2 is a sectional view showing an ultrasonic sensor and its surroundings.

FIG. 3 is a view viewed along an arrow III in FIG. 1.

FIG. 4 is a block diagram showing a structure of a control circuit to the ultrasonic sensor.

FIG. 5 is an explanatory view showing a flow of various signals in a liquid surface level detection control performed by a driving condition computing circuit unit and an arithmetic control circuit unit.

FIG. 6 is an explanatory view showing signal waveforms according to a first embodiment.

FIG. 7A is an explanatory view showing a relationship between a received wave and a threshold, and FIG. 7B is an explanatory view showing a relationship between the received wave and the threshold.

FIG. 8 is a graph showing a relationship between a temperature and a viscosity of fuel.

FIG. 9 is an explanatory view showing signal waveforms according to a second embodiment.

FIG. 10 is an explanatory view showing signal waveforms according to a third embodiment.

FIG. 11 is an explanatory view showing other signal waveforms according to the first embodiment.

FIG. 12 is an explanatory view showing other signal waveforms according to the second embodiment.

### DETAILED DESCRIPTION

Hereinafter, one example of the present disclosure will be described.

According to the one example, a liquid level detector includes a tank that stores liquid, an ultrasonic sensor (ultrasonic vibration element) that emits an ultrasonic wave toward a liquid surface in the tank, a propagation path that is arranged in the tank, and a control circuit that calculates a level of the liquid surface.

In an assumable configuration, the ultrasonic wave which is emitted from the ultrasonic sensor is propagated via the liquid in the propagation path and reflected by the liquid surface. Subsequently, the ultrasonic wave returns and is received by the ultrasonic sensor. Subsequently, the control circuit calculates the level of the liquid surface (liquid level height) based on a propagation velocity of the ultrasonic wave and a time from the emission of the ultrasonic wave to the receiving of the ultrasonic wave.

However, in the assumable configuration, in a case where a temperature of the liquid decreases, a viscosity of fuel rises in general. Due to this, the ultrasonic wave which is propagated in the liquid is attenuated. That is, the ultrasonic wave which is emitted by the ultrasonic sensor is reflected by the liquid surface, and strength of a received wave which is received by the ultrasonic sensor again is decreased. Therefore, detection of the liquid level with high accuracy may be difficult.

According to one example of the present disclosure, a liquid level detector is configured to perform a liquid detection with high accuracy, even if a temperature of liquid changes.

According to one example of the present disclosure, in a first embodiment, the liquid level detector includes an ultrasonic sensor that is configured to emit an ultrasonic wave toward the liquid surface of liquid in a tank, a driving circuit unit that is configured to provide a driving signal to the ultrasonic sensor to emit the ultrasonic wave, a reception circuit unit that is configured to detect a reflected wave signal that corresponds to a reflected wave reflected by the liquid surface from a received signal that is received by the ultrasonic sensor, and an arithmetic control circuit unit that is configured to compute a level of the liquid surface by using the reflected wave signal detected by the reception circuit unit. The liquid level detector further includes a temperature detection unit that is configured to detect a temperature of the liquid and a driving condition computing circuit unit that is configured to instruct the driving circuit unit to increase a strength of the driving signal as the temperature of the liquid that is detected by the temperature detection unit decreases.

In the one example, the strength of the driving signal is increased as the temperature of the fuel decreases. That is, the ultrasonic wave which is emitted by the ultrasonic sensor is increased. Accordingly, a strength of the reflected wave signal are increased. Therefore, a deterioration of the strength of the reflected wave signal which is caused by an attenuation of the ultrasonic wave when the temperature decreases may be compensated. Due to this, the liquid level detection with high accuracy may be performed.

According to the other example of the present disclosure, in a second embodiment, the liquid level detector includes an ultrasonic sensor that is configured to emit an ultrasonic wave toward the liquid surface of liquid in a tank, a driving circuit unit that is configured to provide a driving signal to the ultrasonic sensor to emit the ultrasonic wave, a reception circuit unit that is configured to detect a reflected wave signal that corresponds to a reflected wave reflected by the liquid surface from a received signal that is received by the ultrasonic sensor, and an arithmetic control circuit unit that is configured to compute a level of the liquid surface by using the reflected wave signal detected by the reception circuit unit. The liquid level detector further includes a temperature detection unit that is configured to detect a temperature of the liquid. The arithmetic control circuit unit decreases and sets a threshold signal that is for the reception circuit unit to detect the reflected wave signal as the temperature of the liquid that is detected by the temperature detection unit decreases.

In this example, the threshold signal decreases correspondingly to a reduction in the temperature of the liquid. Therefore, even if the strength of the reflected wave signal is decreased by the attenuation of the ultrasonic wave which is propagated in the liquid with the reduction in the temperature of the liquid, the reflected wave signal may be detected accurately, and the liquid level detection with the high accuracy may be performed.

Multiple embodiments will be described with reference to drawings as follows. In each embodiment, the same reference numerals are given to the structures corresponding to descriptions in preceding embodiment in order to avoid repeated explanation. In each embodiment, in a case where a part of structures is described, other structure which has already been described may be referred and applied to other part in the structure. The present disclosure also includes various combinations and structures of the embodiments and other combinations and configurations including only one element of the embodiments, more of the elements of the embodiments, and less of the elements of the embodiments.

### First Embodiment

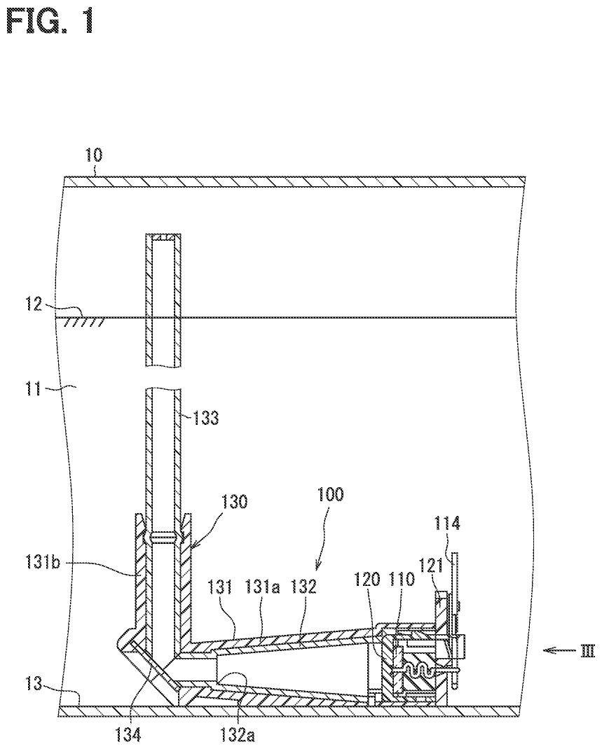

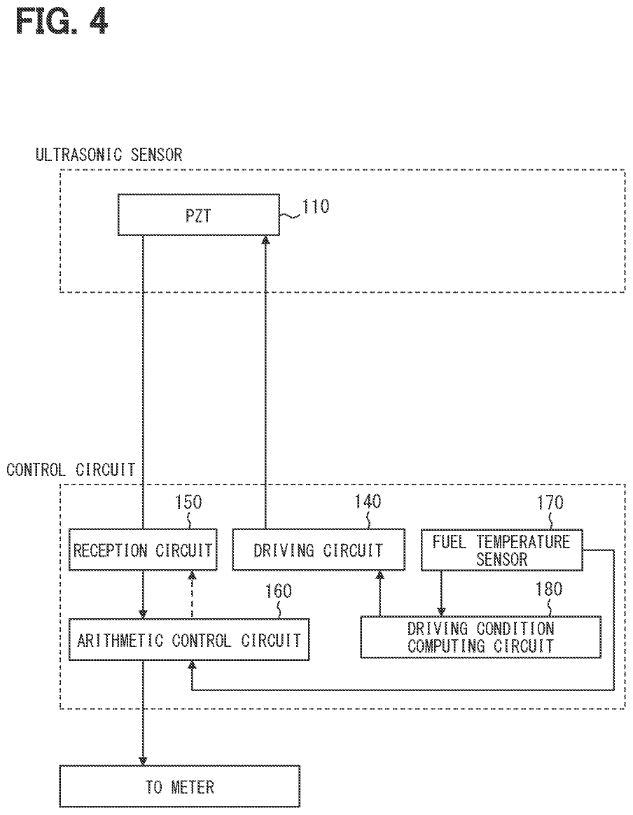

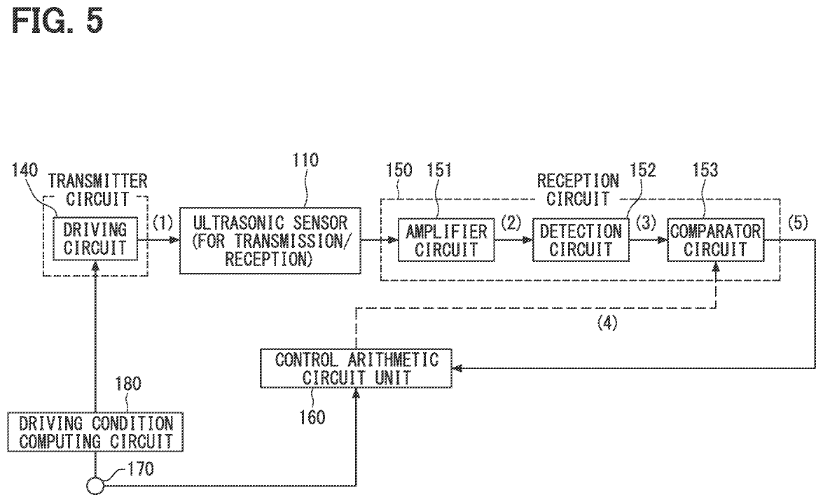

A liquid level detector 100 according to a first embodiment will be described with reference to FIGS. 1 to 8. The liquid level detector 100 is a device which detects a level of a liquid surface 12 of fuel 11, such as gasoline, in a fuel tank 10 for a vehicle or the like. The fuel tank 10 corresponds to a tank, and the fuel 11 corresponds to liquid. As shown in FIGS. 1 to 5, the liquid level detector 100 includes an ultrasonic sensor 110, a case 120, a transmission pipe 130, a driving circuit unit 140, a reception circuit unit 150, an arithmetic control circuit unit 160, a fuel temperature sensor 170, a driving condition computing circuit unit 180, and the like. The ultrasonic sensor 110, the case 120, the transmission pipe 130, the fuel temperature sensor 170, and the like, are placed at a bottom 13 of the fuel tank 10.

The ultrasonic sensor 110 is an ultrasonic transductor and emits an ultrasonic wave toward the liquid surface 12 of the fuel 11 in the fuel tank 10 and a reference surface 132a of a horizontal path 132. The ultrasonic sensor 110 is made of a material which has piezoelectric effect (characteristic that a volume changes when a voltage is applied, on the other hand, a voltage is generated when receiving force from an outside), such as PZT (lead zirconate titanate) or the like, and has a disk shape. The ultrasonic sensor 110 is housed in a space which is formed by the case 120 and a lid 121.

The case 120 has a container form in a bottomed tubular shape and is made of a resin. The case 120 is arranged such that an axis of the tube is directed in a horizontal direction. The lid 121 has a plate form and is made of a resin. The lid 121 closes an opening of the case 120. Two through holes 121a are provided in the lid 121. The ultrasonic sensor 110 abuts against a bottom 120a of the case 120.

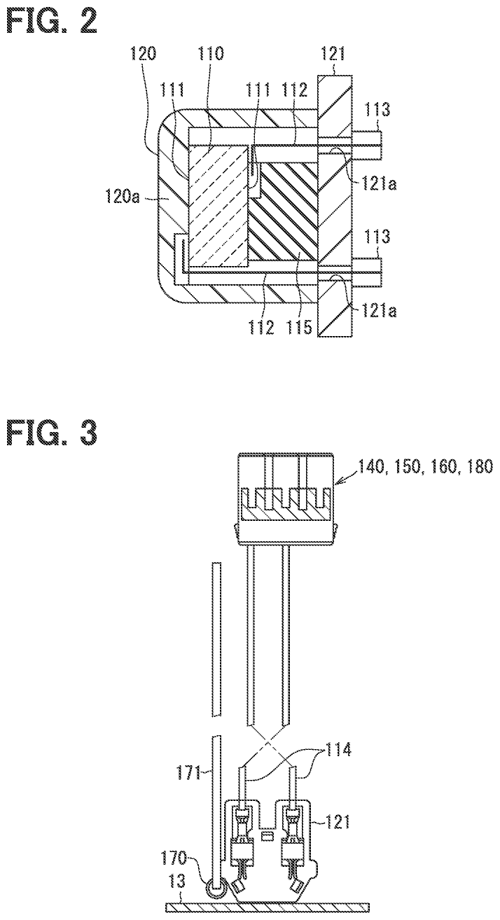

Electrodes 111 are provided on a frontside and a backside of the ultrasonic sensor 110 (left and right side surfaces in FIG. 2). The electrodes 111 are electrically connected to an outside of the ultrasonic sensor 110 and formed by a print molding. Electrodes 111 are provided almost of an entirety of the frontside and almost of an entirety of the backside of the ultrasonic sensor 110, respectively.

Electrodes 111 are connected to one end sides of lead wires 112, respectively, by soldering, pressure welding, or the like. The other ends of the lead wires 112 extend so as to penetrate the through holes 121a of the lid 121. Furthermore, lead wires 114 are connected to terminals 113, respectively.

The ultrasonic sensor 110 is vibrated in an axial direction which is a plate thickness direction (horizontal direction in FIG. 1) by the piezoelectric effect described above, and emits the ultrasonic wave, when the voltage is applied between the electrodes 111.

A vibration proofing member 115 is provided between the ultrasonic sensor 110 and the lid 121 in the case 120. The vibration proofing member 115 is made of a soft resin, a rubber material such as a nitrile rubber, or the like. The lid 121 is fixed to the case 120, and the vibration proofing member 115 is compressed in the case 120 and is elastically deformed. The ultrasonic sensor 110 is pressurized onto the bottom 120a of the case 120 by the elastic force of the vibration proofing member 115.

The vibration proofing member 115 is configured to restrain a reverberation vibration of the ultrasonic sensor 110. In addition, the vibration proofing member 115 is configured to absorb an ultrasonic pulse which is leaked from the ultrasonic sensor 110 to a back of the ultrasonic sensor 110 (a side of the lid 121). Therefore, the ultrasonic pulse which is emitted from the ultrasonic sensor 110 propagates toward the fuel 11 in the horizontal path 132 of the transmission pipe 130 which will be described below.

The transmission pipe 130 propagates the ultrasonic wave which is emitted from the ultrasonic sensor 110 toward the liquid surface 12. In addition, the transmission pipe 130 forms a path (propagation path) which propagates the ultrasonic wave which has been reflected by the liquid surface 12 to the ultrasonic sensor 110. The transmission pipe 130 includes a housing 131, the horizontal path 132, a vertical path 133, a reflector 134, and the like.

The housing 131 is a tubular member and has an L shape. The housing 131 is made of, for example, a resin material which has excellent stability for the fuel 11 in the fuel tank 10. A cross section of the housing 131 has a circular shape. The housing 131 includes a horizontal part 131a and a vertical part 131b. The horizontal part 131a is one side of the L-shaped housing 131, while the vertical part 131b is the other side of the L-shaped housing 131. The horizontal part 131a is fixed to the bottom 13 of the fuel tank 10 such that one end of the vertical part 131b is directed to an upper side. The case 120 (the ultrasonic sensor 110) is fixed to one end of the horizontal part 131a. The bottom 120a of the case 120 is placed so as to enter the one end of the horizontal part 131a in the axial direction.

The horizontal part 131a is formed such that an internal diameter gradually becomes smaller (reduce in diameter) from the case 120 toward the vertical part 131b. On the other hand, one end of the vertical part 131b extends to an intermediate position of the fuel tank 10 in a depth direction.

The horizontal path 132 is a tubular member, and a cross section of the horizontal path 132 has a circular shape. The horizontal path 132 is in contact to an inner side of the horizontal part 131a of the housing 131. The horizontal path 132 is made of a metal material such as a steel (drawing a steel sheet) or the like. The horizontal path 132 may be made of a resin material. Similarly to the horizontal part 131a of the housing 131, the horizontal path 132 is formed such that an internal diameter gradually becomes smaller (reduce in diameter) from the case 120 toward the vertical part 131b.

The reference surface 132a of the horizontal path 132 is placed opposite to the case 120. The reference surface 132a corresponds to a specific base level, and the relative position between the ultrasonic sensor 110 and the specific base level is fixed. A distance between the ultrasonic sensor 110 and the reference surface 132a is a specific reference distance L which is predetermined. The reference surface 132a has a stepped shape in an axial direction of the horizontal path 132 and has a ring shape in a circumferential direction. The reference surface 132a is a surface which is opposed to the ultrasonic sensor 110. Therefore, a part of the ultrasonic wave which is emitted from the ultrasonic sensor 110 enters the reference surface 132a and reflected by the reference surface 132a. Subsequently, the ultrasonic wave progresses toward the ultrasonic sensor 110 and enters the ultrasonic sensor 110.

The fuel 11 enters the horizontal path 132 from an opening which is placed at a lower side of the housing 131 (the bottom 13 side).

The vertical path 133 is a tubular member, and a cross section of the vertical path 133 has a circular shape. One end side of the vertical path 133 is contacted to an inner side of the vertical part 131b of the housing 131. The vertical path 133 is made of a metal material such as a steel (drawing a steel sheet) or the like, similarly to the horizontal path 132. The vertical path 133 may be made of a resin material. The vertical path 133 is substantially orthogonal to the horizontal path 132. That is, the vertical path 133 rises vertically from the bottom 13 of the fuel tank 10. The other end of the vertical path 133 is arranged so as to protrude above the liquid surface 12 by a predetermined length when the fuel tank 10 is full filled with the fuel 11. A diameter of the vertical path 133 is equal to a diameter of the horizontal path 132 at a side in which the diameter is reduced.

The fuel 11 continually enters the vertical path 133 from the horizontal path 132. The upper surface of the fuel 11 in the vertical path 133 has the same level as the liquid surface 12 in the fuel tank 10.

The reflector 134 is a plate member between the horizontal path 132 and the vertical path 133. The reflector 134 is made of, for example, an iron type metal, preferably, a stainless steel plate or the like. The reflector 134 inclines at an angle of around 45° relative to the bottom 13 of the fuel tank 10. The reflector 134 is configured to reflect the ultrasonic wave which is emitted from the ultrasonic sensor 110 toward the liquid surface 12 of the fuel 11. In addition, the reflector 134 is configured to reflect the ultrasonic wave which is reflected at the liquid surface 12 toward the ultrasonic sensor 110.

The driving circuit unit 140 forms a transmitter circuit and is a circuit unit which provides a driving signal (1) to the ultrasonic sensor 110 to emit the ultrasonic wave. The driving circuit unit 140, for example, includes a high-frequency wave oscillator which oscillates the ultrasonic wave at a prescribed frequency and an amplifier circuit which amplifies an oscillation signal. In this state, based on an instruction from the driving condition computing circuit unit 180 which will be described below, the driving circuit unit 140 outputs the driving signal (1) to the ultrasonic sensor 110, and the ultrasonic sensor 110 is driven and emits the ultrasonic wave. The driving circuit unit 140 may not include the high-frequency wave oscillator and may receive a signal which is superimposed with a high-frequency signal from the driving condition computing circuit unit 180.

The reception circuit unit 150 detects a reference wave signal and a liquid surface wave signal from a received signal which is received at the ultrasonic sensor 110. The reference wave signal corresponds to a reflected wave which is reflected from the reference surface 132a of the horizontal path 132. The liquid surface wave signal corresponds to a reflected wave which is reflected from the liquid surface 12. The reference wave signal also corresponds to a reference reflected wave signal, and the liquid surface wave signal also corresponds to a reflected wave signal. The reception circuit unit 150 includes an amplifier circuit 151, a detection circuit 152, and a comparator circuit 153.

The amplifier circuit 151 amplifies a signal which is received at the ultrasonic sensor 110 (the reference wave signal and the liquid surface wave signal) and produces an amplified signal (2). The detection circuit 152 implements a half-wave rectification on the amplified signal (2) and converts the amplified signal (2) into a detection signal (3). The detection signal (3) is formed as a signal which connects peaks of the waveforms rectified by the half-wave (FIGS. 7A and 7B). The comparator circuit 153 performs a comparison processing between the detection signal (3) and a threshold signal (4) which is output from the arithmetic control circuit unit 160. Further, the comparator circuit 153 outputs the signal which is in a region larger than the threshold signal (4) in the detection signal (3) as a comparator signal (5) to the arithmetic control circuit unit 160.

The arithmetic control circuit unit 160 computes the level of the liquid surface 12 with the reference wave signal from the reception circuit unit 150 and the comparator signal (5) of the liquid surface wave signal. The details will be described below.

The fuel temperature sensor 170 detects a temperature of the fuel 11. The fuel temperature sensor 170 corresponds to a temperature detection unit. As shown in FIG. 3, the fuel temperature sensor 170, for example, is adjacent to the case 120 and is in the vicinity of the bottom 13 of the fuel tank 10. The fuel temperature sensor 170 is in contact to the fuel 11 directly and detects the temperature of the fuel 11. A lead wire 171 connects the fuel temperature sensor 170 to the arithmetic control circuit unit 160 and the driving condition computing circuit unit 180 which will be described below. The fuel temperature sensor 170 detects a temperature and outputs a temperature signal to the arithmetic control circuit unit 160 and the driving condition computing circuit unit 180.

The driving condition computing circuit unit 180 instructs the driving circuit unit 140 to change a magnitude of the driving signal (1) corresponding to the temperature of the fuel 11 which is detected by the fuel temperature sensor 170. More specifically, the driving condition computing circuit unit 180 instructs to increase a strength of the driving signal (1) as the temperature of the fuel 11 decreases.

In addition, in this embodiment, the arithmetic control circuit unit 160 described above sets the threshold signal (4) which is to detect the liquid surface wave signal and the reference wave signal so as to become smaller as the temperature of the fuel 11 decreases. The threshold signal (4) is an identical signal to detect the liquid surface wave signal and the reference wave signal. The threshold signal (4) to the reference wave signal corresponds to a reference threshold signal.

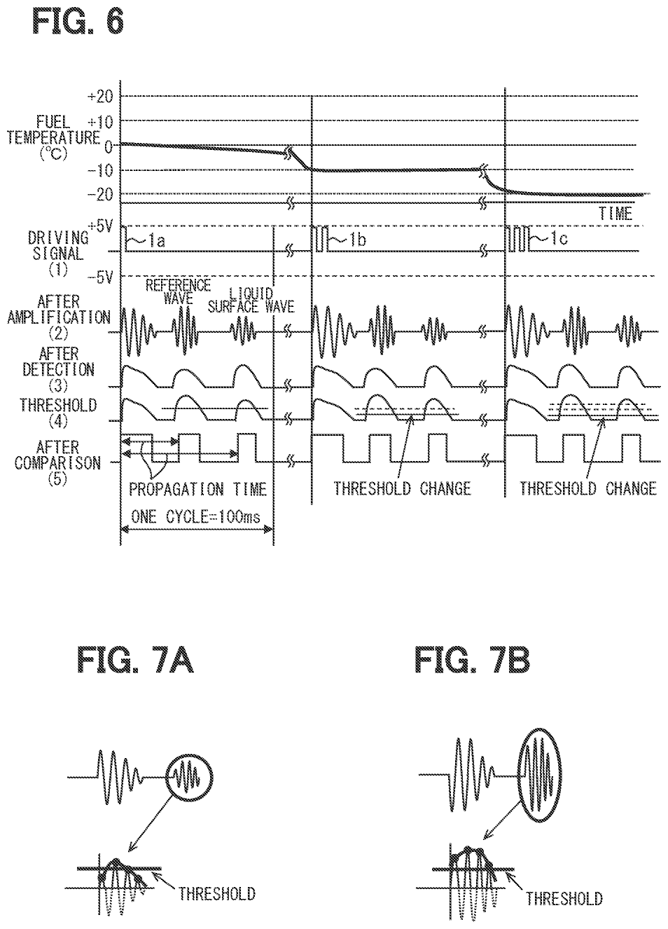

The liquid level detector 100 is configured as described the above. An operation and operational effects of the liquid level detector 100 will be described below additionally with reference to FIGS. 6 to 8.

First, for example, when a control time of one cycle is a slight time about 100 ms, the driving condition computing circuit unit 180 transmits an instruction to the driving circuit unit 140 at a beginning of one cycle. Subsequently, the driving condition computing circuit unit 180 causes the driving circuit unit 140 to output the driving signal (1) to the ultrasonic sensor 110. The control time is a time in which the reception of the reference wave signal and the liquid surface wave signal becomes possible and is not limited as 100 ms. In addition, the driving signal (1) is, for example, based on a rectangular wave of positive electric potential at around +5 V. The driving condition computing circuit unit 180 repeats the instruction to the driving circuit unit 140 at each cycle.

At this point, the driving condition computing circuit unit 180 instructs the driving circuit unit 140 to change the magnitude (strength) of the driving signal (1) correspondingly to the temperature signal which is obtained from the fuel temperature sensor 170. For example, when a fuel temperature is around 0° C., the driving condition computing circuit unit 180 instructs to change the driving signal (1) to a driving signal (1a) which includes one positive electric potential. When the fuel temperature is around −10° C., the driving condition computing circuit unit 180 instructs to change the driving signal (1) to a driving signal (1b) which includes two consecutive positive electric potentials. When the fuel temperature is around −20° C., the driving condition computing circuit unit 180 instructs to change the driving signal (1) to a driving signal (1c) which includes three consecutive positive electric potentials.

The arithmetic control circuit unit 160 sets the threshold signal (4) to gradually become smaller as the magnitude of the driving signal (1) is changed larger (as temperature signal becomes lower) correspondingly to the temperature signal. The threshold signal (4) is to detect a detection waveform of the liquid surface wave signal and the reference wave signal.

The ultrasonic sensor 110 emits the ultrasonic wave based on the driving signal (1a, 1b, 1c) from the driving circuit unit 140. The ultrasonic wave which is emitted becomes stronger as the driving signal (1a, 1b, 1c) is set larger. The ultrasonic wave which is emitted is propagated in the transmission pipe 130.

A part of the ultrasonic wave which is propagated is reflected by the reference surface 132a in the horizontal path 132. Subsequently, the ultrasonic sensor 110 receives the ultrasonic wave as the reference wave signal. The other part of the ultrasonic wave which is propagated is propagated via the horizontal path 132, the reflector 134, and the vertical path 133, and reflected by the liquid surface 12. Subsequently, the ultrasonic wave is propagated in the opposite direction to the above, and the ultrasonic sensor 110 receives the ultrasonic wave as the liquid surface wave signal.

The reception circuit unit 150 generates the amplified signal (2), the detection signal (3), and the comparator signal (5) from the reference wave signal and the liquid surface wave signal which are emitted from the ultrasonic sensor 110. Subsequently, the reception circuit unit 150 outputs the comparator signal (5) to the arithmetic control circuit unit 160.

The arithmetic control circuit unit 160 calculates (grasps) a reference speed (=2×reference distance L/propagation time) of the ultrasonic wave based on the temperature at that time. The reference speed is calculated from a distance of one round trip (2×L) between the ultrasonic sensor 110 and the reference surface 132a and from a propagation time of the reference wave signal from the emission to the receiving. Further, the arithmetic control circuit unit 160 calculates a distance (=velocity of the ultrasonic wave×propagation time/2) between the ultrasonic sensor 110 and the liquid surface 12 from the calculated reference speed and a propagation time of the liquid surface wave signal from the emission to the receiving. Based on the distance between the ultrasonic sensor 110 and the liquid surface 12, the level of the liquid surface 12 is calculated.

The arithmetic control circuit unit 160 transmits the data of the calculated level of the liquid surface 12 to a liquid level display device (for example, a fuel remaining level display part of a combination meter) of the vehicle, or the like. The liquid level display device of the vehicle captures the level data of the liquid surface for prescribed times (for example 32 times) during a repetitive control and calculates the average value of the level data. The liquid level display device displays the average value as the liquid level.

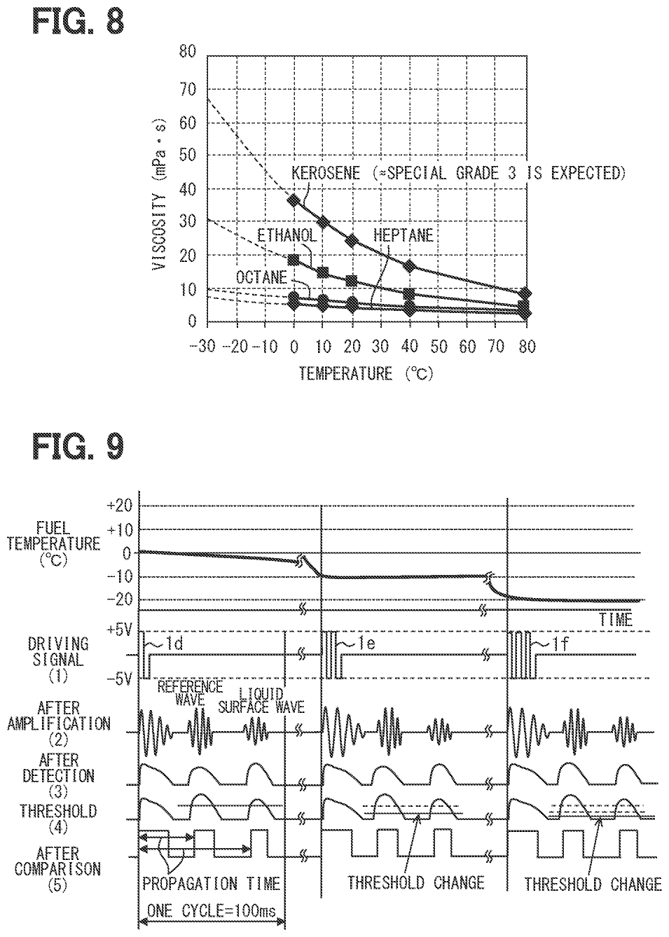

As shown in FIG. 8, in a case where the temperature of the fuel 11 decreases, the viscosity of the fuel 11 rises, and the ultrasonic wave which is propagated in the fuel 11 is attenuated. The ultrasonic wave which is emitted from the ultrasonic sensor 110 is reflected by the liquid surface 12 and the reference surface 132a. Due to this, the strength of a received wave (liquid surface wave signal and reference wave) which is received by the ultrasonic sensor 110 again is decreased. Therefore, detection of the liquid level with high accuracy may be difficult.

As a case where the temperature of the fuel 11 decreases, for example, a case where the fuel 11 is supplied during driving of the vehicle can be given. When fuel 11 is supplied, the fuel 11 at low temperature is supplied to fuel 11 in the fuel tank 10. Accordingly, the temperature of the fuel 11 in the fuel tank 10 greatly decreases. In this case, the liquid level detector 100 (accuracy of liquid level detection) is more affected by the temperature of the fuel 11.

In this embodiment, the strength of the driving signal (1) is increased as the temperature of the fuel 11 decreases. That is, the ultrasonic wave which is emitted by the ultrasonic sensor 110 is increased. Accordingly, a strength of the liquid surface wave signal and a strength of the reference wave signal are increased. Therefore, a deterioration of the strength of the liquid surface wave signal and the reference wave signal which is caused by the attenuation of the ultrasonic wave when the temperature decreases may be compensated. Due to this, the liquid level detection with high accuracy may be performed.

In addition, in this embodiment, the threshold signal (4) decreases correspondingly to a reduction in the temperature of the fuel 11. Therefore, even if the strength of the liquid surface wave signal and the reference wave signal is decreased by the attenuation of the ultrasonic wave which is propagated in the fuel 11 with the reduction in the temperature of the fuel 11, the liquid surface wave signal and the reference wave signal may be detected accurately, and the liquid level detection with high accuracy may be performed.

### Second Embodiment

A second embodiment is shown in FIG. 9. A structure of the liquid level detector 100 in the second embodiment is same as that in the first embodiment. A form of a driving signal (1) in the second embodiment is different from that in the first embodiment.

In this embodiment, differently from the first embodiment, the driving signal (1) is based on a rectangular wave which is a combination of a positive electric potential and a negative electric potential. A magnitude (strength) of the driving signal (1) is changed correspondingly to the temperature signal which is obtained from the fuel temperature sensor 170. For example, when the fuel temperature is around 0° C., the driving signal (1) is set at a driving signal (1d) which includes one positive and negative electric potential. When the fuel temperature is around −10° C., the driving signal (1) is set at a driving signal (1e) which includes two consecutive positive and negative electric potentials. When the fuel temperature is around −20° C., the driving signal (1) is set at a driving signal (1f) which includes three consecutive positive and negative electric potentials.

To the liquid surface wave signal and the reference wave signal, similarly to the first embodiment, the threshold signal (4) is decreased in turn as the temperature signal becomes lower.

In this embodiment, the form of the driving signal (1) is different from that in the first embodiment. The second embodiment enables to have the same effect as the first embodiment.

### Third Embodiment

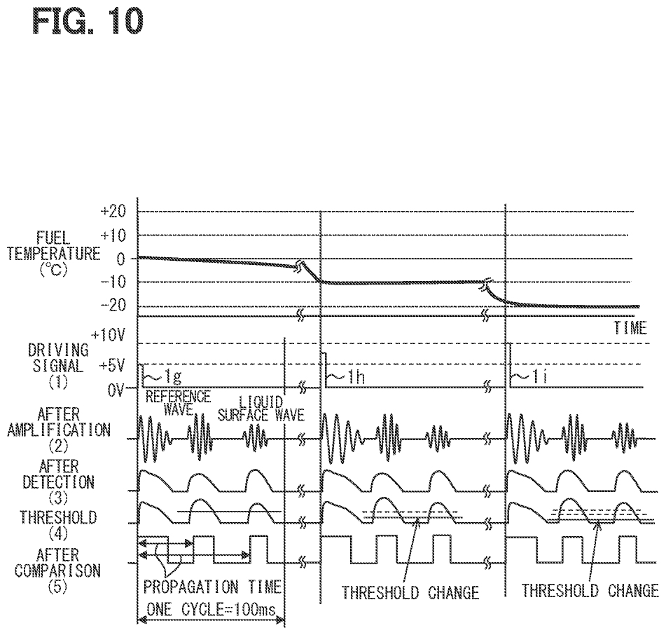

A third embodiment is shown in FIG. 10. A structure of the liquid level detector 100 in the third embodiment is same as that in the first embodiment. A form of a driving signal (1) in the third embodiment is different from that in the first embodiment.

In this embodiment, similarly to the first embodiment, the driving signal (1) is based on a rectangular wave with the positive electric potential. A magnitude (strength) of the driving signal (1) is changed correspondingly to the temperature signal which is obtained from the fuel temperature sensor 170. For example, when the fuel temperature is around 0° C., the driving signal (1) is set at a driving signal (1g) at around +5 V. When the fuel temperature is around −10° C., the driving signal (1) is set at a driving signal (1h) at around +7.5 V. When the fuel temperature is around 20° C., the driving signal (1) is set at a driving signal (1i) at around +10V.

To the liquid surface wave signal and the reference wave signal, similarly to the first embodiment, the threshold signal (4) is decreased in turn as the temperature signal becomes lower.

In this embodiment, the form of the driving signal (1) is different from that in the first embodiment. The third embodiment enables to have the same effect as the first embodiment.

Variations of the present disclosures in above will be described below. In the embodiments described in the above, as the fuel temperature decreases, the strength of the driving signal (1) is increased and the threshold signal (4) becomes lower. However, either one of the increasing of the strength of the driving signal (1) or the reducing of threshold signal (4) may be made.

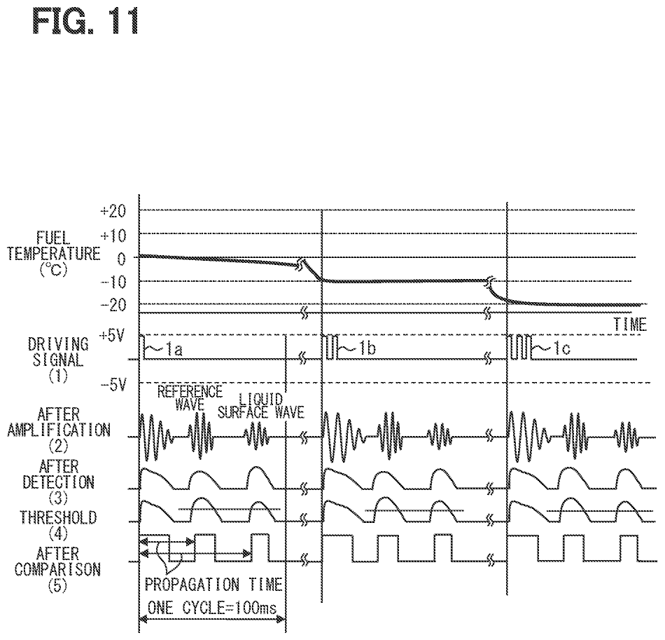

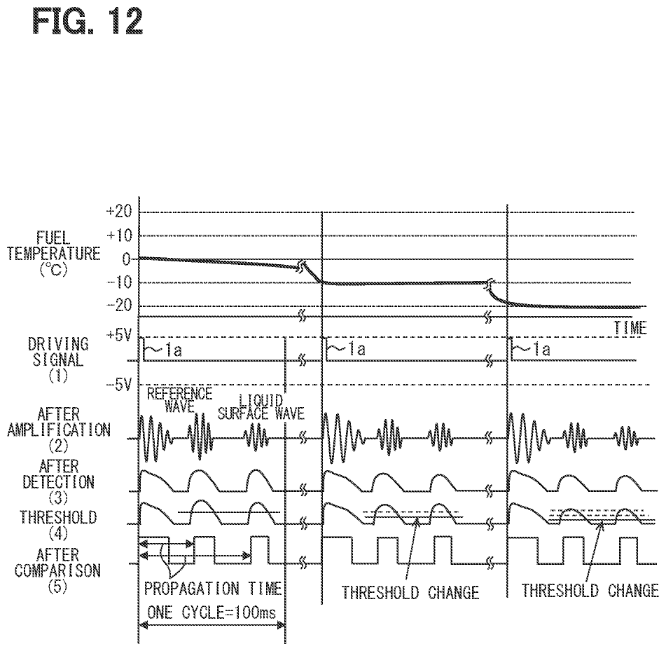

For example, as shown in FIG. 11, only the strength of the driving signal (1) may be increased (1a, 1b, 1c) as the fuel temperature decreases, while the threshold signal (4) keeps the same strength regardless of the fuel temperature. Otherwise, as shown in FIG. 12, the threshold signal (4) may be decreased as the fuel temperature decreases, while the driving signal (1) keeps the same strength regardless of the fuel temperature.

In the embodiments described in the above, the fuel temperature sensor 170 as the temperature detection unit is housed in the fuel tank 10. However, the present disclosure is not limited to this configuration. The fuel temperature sensor 170 may be placed at an outside of the fuel tank 10, for example, at a surface of a fuel pipe or the like. Thereby, the temperature of the fuel 11 may be detected indirectly.

In the embodiments described in the above, the rectangular wave is mainly used as the driving signal (1). However, the present disclosure is not limited to this configuration. A trapezoidal wave, a half wave of a sine wave, a sine wave, or the like may be used as the driving signal (1), instead of the rectangular wave.

As described in the first embodiment, the temperature of the fuel 11 changes mainly when fuel is supplied. Therefore, a control based on the temperature of the fuel 11 may be performed based on a condition when the oil is supplied such as a vehicle power supply state, a speed condition, an open/closed state of an oil inlet cap, a degree of a change of the liquid surface 12, or the like.

In the embodiments described in the above, the reference wave signal is used to compute the reference speed of the ultrasonic wave based on the temperature. The reference speed of the ultrasonic wave based on the temperature at that time is used to compute the level of the liquid surface 12. Instead of this, the liquid level detector 100 may compute the level of the liquid surface 12 by using the liquid surface wave signal by calculating a velocity of the ultrasonic wave corresponding to the temperature of the fuel 11, without setting of the reference surface 132a. In this case, handling of the reference wave is not required. Therefore, a control to change the magnitude of the threshold signal (4) with respect to the liquid surface wave signal may be performed correspondingly to the temperature of the fuel 11, while a control to change a magnitude of the threshold signal (4) with respect to the reference wave signal is not required.

In the embodiments described in the above, the liquid level detector 100 detects the level of the liquid surface 12 of the fuel 11 in the fuel tank 10. However, the liquid level detector 100 may be widely used to detect a position of liquid surface not only of the fuel 11, but also washer liquid, cooling liquid, brake oil, AT fluid, or the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

The present disclosure has been described according to the present embodiments. However, the present disclosure is not limited by the embodiments or structure. The present disclosure encompasses various variations and modifications within equivalents. This present disclosure also encompasses various combinations and embodiments, and furthermore, encompasses one or more or less of elements and combinations thereof.

1. A liquid level detector comprising:
an ultrasonic sensor configured to emit an ultrasonic wave toward a liquid surface of liquid in a tank;
a driving circuit unit configured to provide a driving signal to the ultrasonic sensor to emit the ultrasonic wave;
a reception circuit unit configured to detect a reflected wave signal that corresponds to a reflected wave reflected by the liquid surface from a received signal that is received by the ultrasonic sensor;
an arithmetic control circuit unit configured to compute a level of the liquid surface by using the reflected wave signal detected by the reception circuit unit;
a temperature detection unit configured to detect a temperature of the liquid; and
a driving condition computing circuit unit configured to instruct the driving circuit unit to increase a strength of the driving signal as the temperature of the liquid that is detected by the temperature detection unit decreases.

2. A liquid level detector comprising:
an ultrasonic sensor configured to emit an ultrasonic wave toward a liquid surface of liquid in a tank;
a driving circuit unit configured to provide a driving signal to the ultrasonic sensor to emit the ultrasonic wave;
a reception circuit unit configured to detect a reflected wave signal that corresponds to a reflected wave reflected by the liquid surface from a received signal that is received by the ultrasonic sensor;
an arithmetic control circuit unit configured to compute a level of the liquid surface by using the reflected wave signal detected by the reception circuit unit; and
a temperature detection unit configured to detect a temperature of the liquid, wherein
the arithmetic control circuit unit is configured to decrease and set a threshold signal that is for the reception unit to detect the reflected wave signal as the temperature of the liquid that is detected by the temperature detection unit decreases.

3. The liquid level detector according to claim 2, wherein
the reception circuit unit is configured to detect the reflected wave signal and is further configured to detect a reference reflected wave signal that corresponds to a reflected wave reflected by a specific reference surface,
a relative position between the ultrasonic sensor and the specific reference surface is fixed, and
the control arithmetic circuit unit is configured
to grasp a reference speed of the ultrasonic wave by using the reference reflected wave signal
to compute the level of the liquid surface by using the reflected wave signal with the reference speed and
to reduce and set a reference threshold signal that is for detecting the reference reflected wave signal, as the temperature of the liquid decreases.

4. A liquid level detector comprising:
a processor configured
to provide a driving signal to an ultrasonic sensor to cause the ultrasonic sensor to emit an ultrasonic wave toward a liquid surface of liquid in a tank
to detect a reflected wave signal that corresponds to a reflected wave reflected by the liquid surface from a received signal received by the ultrasonic sensor
to compute a level of the liquid surface from the reflected wave signal
to detect a temperature of the liquid and
to increase a strength of the driving signal, as the temperature of the liquid surface decreases.
